(19) United States
(12) Patent Application Publication
(10) Pub. No.: US 2024/0356390 A1
(43) Pub. Date: Oct. 24, 2024

(54) ENCAPSULATION RECEPTACLE FOR WELDED STATOR WIRE ENDS

(71) Applicant: AISIN Corporation, Kariya Aichi (JP)

(72) Inventors: Saida Khan, Canton, MI (US); Kaname Matsuyama, Novi, MI (US)

(73) Assignee: AISIN Corporation, Kariya Aichi (JP)

(21) Appl. No.: 18/303,658

(22) Filed: Apr. 20, 2023

(51) Int. Cl. H02K 1/20; H02K 3/32

(52) U.S. Cl. CPC H02K 1/20; H02K 3/32

(57) ABSTRACT

An encapsulation receptacle for a motor stator assembly defines a cavity structured to receive welded portions of stator wire ends therein. The stator may be supported above the encapsulation receptacle so that portions of the wire ends are positioned in the cavity. In an encapsulation procedure, an encapsulation material is introduced into the cavity to surround the portions of the wire ends, which immobilizes the portions of the wire ends with respect to each other and electrically insulates the portions of the wire ends from each other. During the encapsulation procedure, the receptacle becomes affixed to the encapsulation, thereby becoming a part of the stator assembly. The receptacle may incorporate features designed to guide a liquid coolant flowing through the cavity during operation of the motor. The receptacle may also serve to protect the encapsulation against damage or intrusion by contaminants.

### TECHNICAL FIELD

The embodiments disclosed herein relate to structures usable for insulating exposed wires of stators for electric motors and, more particularly, to structures for insulating the welded portions of stator hairpin or I-pin type magnetic coil wires of electric vehicle motors.

### BACKGROUND

Currently, stator magnetic coil wire ends for electric motors are joined by welding. The insulation coating around the wire ends is stripped to permit welding of the wire ends. To prevent electrical shorting of the wire ends and welded portions, it is necessary to electrically insulate the exposed wires and welded portions of the wire ends from each other after welding. It is also desirable to cool the stator wires during operation of the motor. Thus, a liquid coolant material may be circulated among the portions of the wires residing between the covering and the stator. However, the flow of this coolant material may be difficult to control, resulting in undesirable “hot spots” in the mass of stator wires.

### SUMMARY

In one aspect of the embodiments described herein, an encapsulation receptacle for a motor stator assembly is provided. The receptacle includes an annular base portion, an inner wall extending from the base portion, and an outer wall extending from the base portion opposite the inner wall. The base portion, the inner wall, and the outer wall combine to define a cavity structured to hold a quantity of encapsulation material inserted therein. An inner wall extension extends from the inner wall in a direction toward the central axis. An outer wall extension extends from the outer wall in a direction away from the central axis. At least one drain passage extends through at least one of the outer wall extension and the inner wall extension. The drain passage(s) is structured to enable drainage of a cooling fluid from the cavity.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

It will be appreciated that for simplicity and clarity of illustration, where appropriate, reference numerals may have been repeated among the different figures to indicate corresponding or analogous elements. Also, similar reference numerals appearing in different views may refer to similar elements appearing in those views. In addition, the discussion outlines numerous specific details to provide a thorough understanding of the embodiments described herein. Those of skill in the art, however, will understand that the embodiments described herein may be practiced using various combinations of these elements.

FIG. 1A is a schematic perspective view of an encapsulation receptacle in accordance with an embodiment described herein.

FIG. 1B is a schematic plan view of the encapsulation receptacle shown in FIG. 1A.

FIG. 1C is a schematic cross-sectional view of the receptacle shown in FIGS. 1A and 1B.

FIG. 1D is a schematic cross-sectional view of a portion of an encapsulation receptacle showing one example of a gap formed in an outer wall extension of the receptacle for cooling material inflow or outflow.

FIG. 1E is a schematic cross-sectional view showing a stator having wire ends extending from a stator body a first distance D1 into an embodiment of the encapsulation receptacle.

FIG. 1F is a magnified view of a portion of the cross-section shown in FIG. 1E.

FIG. 2A is a schematic perspective view of an encapsulation receptacle in accordance with another embodiment described herein.

FIG. 2B is a schematic plan view of the encapsulation receptacle shown in FIG. 2A.

FIG. 3 is a schematic partial cross-sectional view showing a portion of another embodiment of the encapsulation receptacle having a through-hole extending through an outer wall extension of the receptacle for entry of coolant fluid.

FIG. 4A is a schematic cross-sectional view of another stator having wire ends extending a second distance D2 into an encapsulation receptacle from a stator body, where the second distance D2 is relatively greater than the first distance D1 shown in FIG. 1E.

FIG. 4B is a schematic cross-sectional view of a portion of the receptacle shown in FIG. 4A.

FIG. 4C is a schematic plan view of the receptacle shown in FIG. 4A.

FIG. 5 is a schematic cross-sectional view similar to the view of FIG. 1C, showing another alternative embodiment of the receptacle.

FIGS. 6A-6C are schematic perspective views illustrating steps of an exemplary encapsulation method incorporating an embodiment of the encapsulation receptacle described herein.

### DETAILED DESCRIPTION

This disclosure relates to a stator assembly for an electric motor, and to an encapsulation receptacle for the stator assembly. The stator assembly may include a motor stator having a stator body and a plurality of wire ends extending from the stator body. The encapsulation receptacle may define a cavity structured to receive portions of the wire ends therein. The stator may be supported or suspended above the encapsulation receptacle so that portions of the wire ends are positioned in the cavity. In an encapsulation procedure, an encapsulation material is introduced into the cavity to surround the portions of the wire ends. The encapsulation material is hardened to form an encapsulation which immobilizes the portions of the wire ends with respect to each other and electrically insulates the portions of the wire ends from each other. During the encapsulation procedure, the receptacle becomes affixed to the encapsulation, thereby becoming a part of the stator assembly. The receptacle may incorporate features designed to guide a liquid coolant flowing through the cavity during operation of the motor. The receptacle may also serve to protect the encapsulation against damage or intrusion by contaminants.

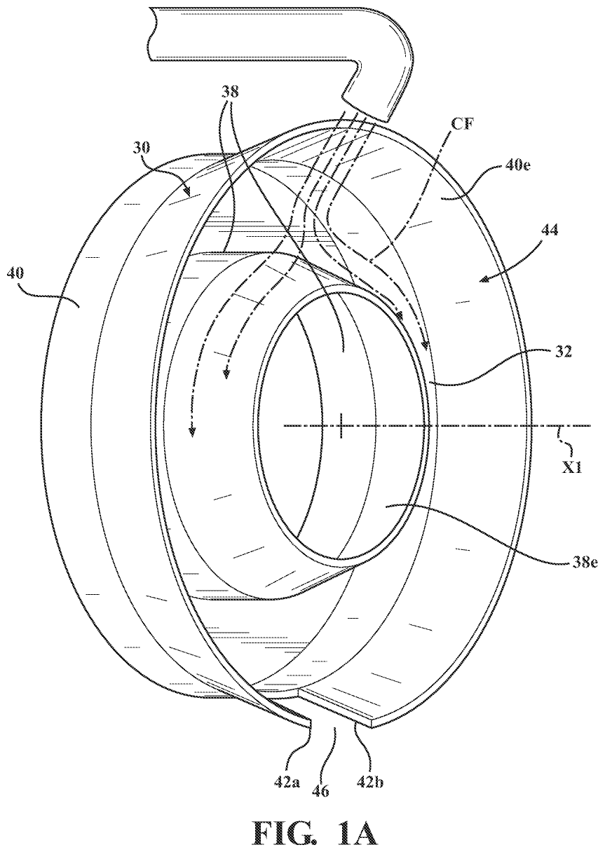

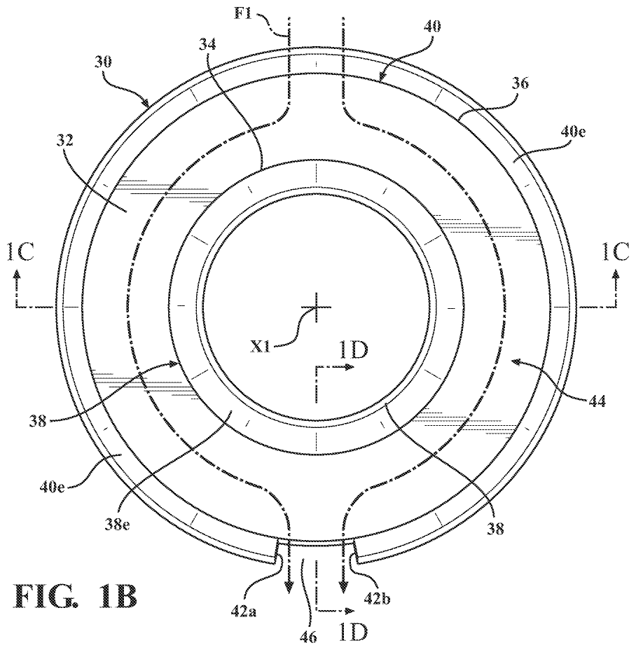

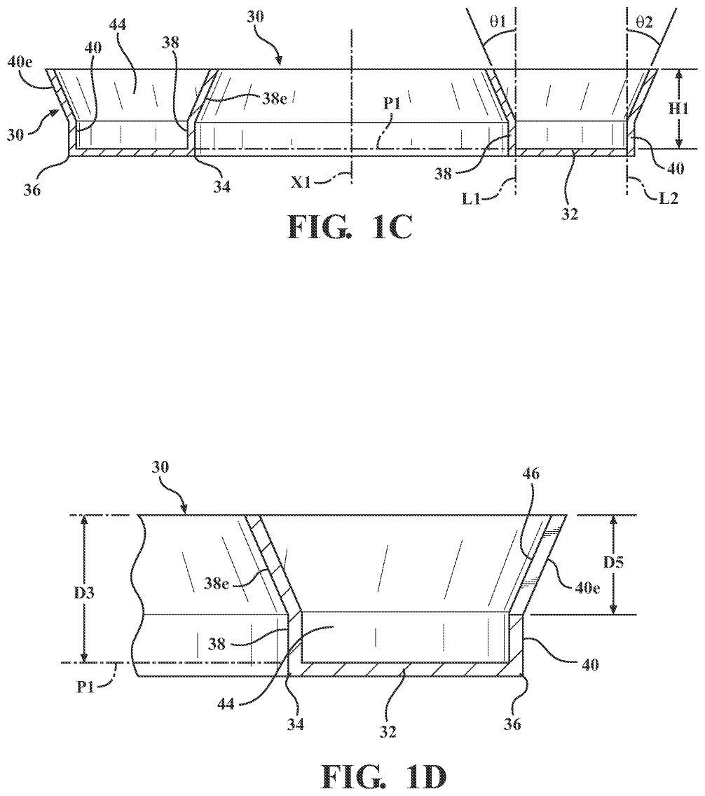

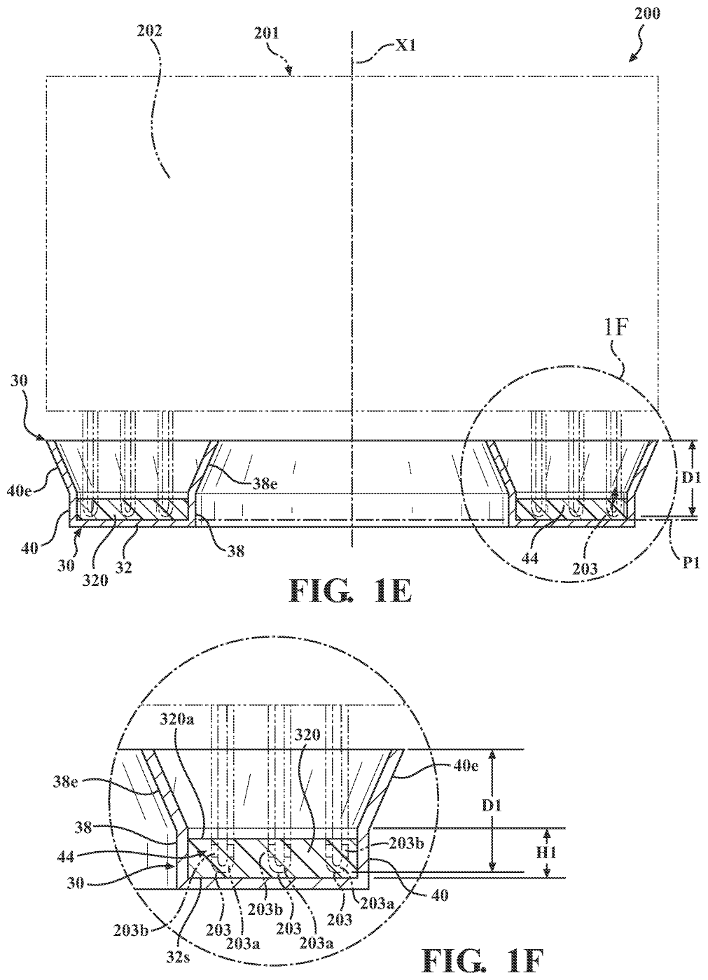

FIGS. 1A-5 show various embodiments and features of an encapsulation receptacle for a motor stator assembly. FIG. 1A is a schematic perspective view of an encapsulation receptacle 30 in accordance with an embodiment described herein. FIG. 1B is a schematic plan view of the encapsulation receptacle 30 shown in FIG. 1A. FIG. 1C is a schematic cross-sectional view of the receptacle 30 shown in FIGS. 1A and 1B.

Referring to FIGS. 1A-1C and 1E, in one or more arrangements, the encapsulation receptacle 30 may include an annular base portion 32 structured to conform to the annular shape of an arrangement of a grouping of wire ends extending from an associated motor stator (not shown). The annular base portion 32 may have a central axis X1 extending therethrough. The annular base portion 32 may also have a radially innermost edge (or “inner edge”) 34 and a radially outermost edge (or “outer edge”) 36.

An inner wall 38 may extend from the base portion 32, and an outer wall 40 may extend from the base portion 32 opposite the inner wall 38. In particular arrangements, the inner wall 38 extends from the inner edge 34 of the base portion 32 and the outer wall 40 extends from the outer edge 36 of the base portion opposite the inner wall 38. In addition, the base portion 32, the inner wall 38, and the outer wall 40 may combine to define a cavity 44 structured to receive a plurality of stator wire ends 203 (seen in FIG. 1E) of an associated motor stator 201. As described herein, the cavity 44 may also be structured to receive and hold therein a quantity of encapsulation material (such as an epoxy potting material for example) structured to encapsulate the wire ends.

In one or more arrangements, an inner wall extension 38e may extend from the inner wall 38 in a direction toward the central axis X1. Also, an outer wall extension 40e may extend from the outer wall 40 in a direction away from the central axis X1. At least one drain passage 46 may extend through at least one of the outer wall extension 40e and the inner wall extension 38e. The at least one drain passage 46 may be structured to enable drainage of a cooling fluid from the cavity 44.

The arrangement of FIGS. 1A-1C may be employed for a receptacle 30 that is to be oriented as shown in FIG. 1A during operation of the motor, with both a central axis of the stator and the central axis X1 of the receptacle 30 extending generally horizontally. In this arrangement, the inner wall extension 38c may function as an impingement surface for guiding cooling fluid CF entering the cavity 44 through a cooling fluid feed pipe 51 extending over the outer wall extension 40c. The inner wall extension 38e may guide the cooling fluid CF therealong so that the cooling fluid CF proceeds along the cavity 44 as indicated by the arrows to cool wire end portions as shown in FIG. 1E residing in the cavity between the stator body (not shown) and the encapsulation 20 affixed to the receptacle 30. The cooling fluid CF may flow along the cavity 44 under the force of gravity, channeled between the receptacle inner and outer walls 38, 40 and between the inner wall extension 38e and the outer wall extension 40e until it reaches the drain passage 46 formed in the outer wall extension 40c.

Referring to FIG. 1C, in one or more arrangements, the inner wall 38 may extend perpendicularly from the inner edge 34 of the base portion 32. The outer wall 40 may extend perpendicularly from the outer edge 36 of the base portion opposite the inner wall 38. In addition, in one or more arrangements, the inner wall extension 38c may extend from the inner wall 38 in a direction toward the central axis X1 so as to form an angle θ1 in the range 0°-30° inclusive with respect to a line L1 extending parallel to the central axis X1 and intersecting the base portion inner edge 34. Also, in one or more arrangements, the outer wall extension 40e may extend from the outer wall 40 in a direction away from the central axis X1 so as to form an angle θ2 in the range 0°-30° inclusive with respect to a line L2 extending parallel to the central axis X1 and intersecting the base portion outer edge 36.

Referring to FIG. 1D, in one or more arrangements, the inner wall extension 38e may extend to a first perpendicular distance D3 from a plane of the base portion 32, and the outer wall extension 40e may also extend to the first perpendicular distance D3 from the plane of the base portion 32. In one or more arrangements, the plane of the base portion may be a plane P1 defined by an interior surface of the base portion 32 defining the cavity 44.

At least one cooling fluid drain passage may also extend through at least one of the outer wall extension 40e and the inner wall extension 38c. The drain passage(s) may be structured to enable drainage of a cooling fluid CF from the cavity 44. In one or more arrangements, the drain passage may be in the form of a gap formed in at least one of the outer wall extension 40e and the inner wall extension 38e. FIGS. 1A and 1B show an example of a drain passage in the form of a gap 46 provided in the outer wall extension 40e. For purposes described herein, a “gap” in a wall may be a through-opening which is open or unbounded by a portion of the wall along at least one side thereof. Referring to FIG. 1D, in one or more arrangements, a gap in a wall (such as gap 46 in outer wall extension 40c) may extend partially along a depth dimension D5 of the inner wall extension 38e or the outer wall extension 40c. In such arrangements, a gap in the wall may essentially be defined by two opposed end edges of the wall (such as end edges 42a and 42b of outer wall extension 40e shown in FIGS. 1A and 1B). Also, the angular extent of the gap (i.e., the arc length of the gap extending between the two opposed end edges of the wall) may be varied according to the requirements of a particular application. By controlling the size of the gap and the arrangement of the various walls and wall extensions, various cooling fluid flow characteristics (e.g., cooling fluid drainage rate and flow direction) may be controlled as described herein. In alternative arrangements, the at least one drain passage may be in the form of one or more through-holes extending through the outer wall extension 40c.

FIG. 1E is a schematic cross-sectional view showing a stator 201 having wire ends 203 extending from a stator body 202 a first distance D1 into the encapsulation receptacle 30. FIG. 1F is a magnified view of a portion of the cross-section shown in FIG. 1E. Referring to FIGS. 1E and 1F, the depth of the cavity 44 may be defined by a height H1 of the inner wall above an interior surface 32s of the base portion 32 defining the cavity 44. This depth H1 may be specified so as to be sufficient to enable immersion of both the welded portions 203a of the stator wire ends 203 and also unwelded portions 203b of the wire ends adjacent the welded portions, into the pool of encapsulation material 320 held in the cavity 44. These adjacent portions 203b of the wire ends 203 have been stripped of their magnetic wire coating or insulation to enable welding of the wire ends 203a. The encapsulation 320 may be structured to surround and protect both the welded wire ends 203a and these exposed wire portions 203b. The optimum depth dimension H1 may be determined by experimentation for a given design of motor stator assembly, considering the type of weld, the amount of insulation that must be stripped from a wire to enable a given type of weld, and other pertinent factors.

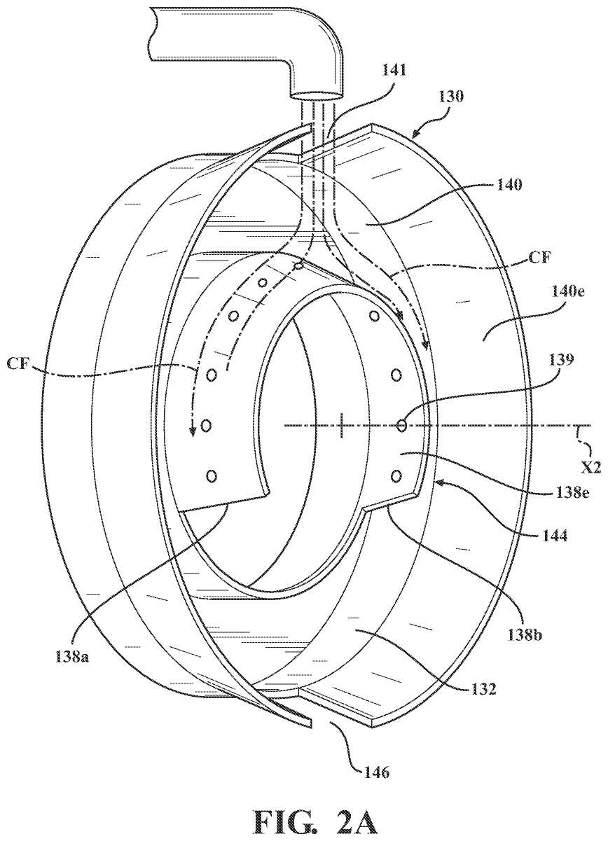

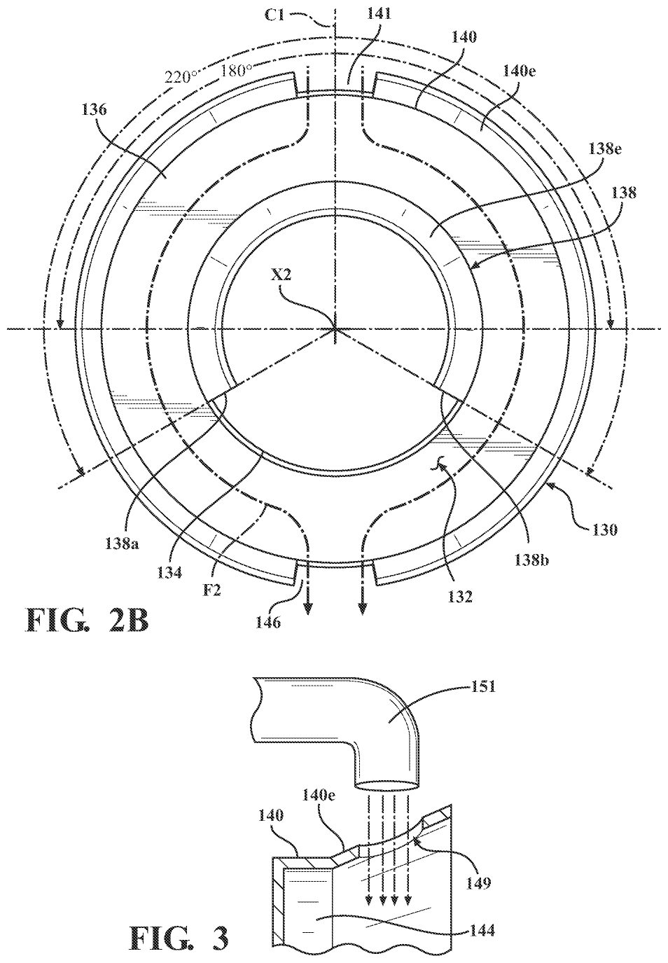

FIG. 2A is a schematic perspective view of an encapsulation receptacle 130 in accordance with another embodiment described herein. FIG. 2B is a schematic plan view of the encapsulation receptacle 130 shown in FIG. 2A. Unless otherwise described, the receptacle embodiment shown in FIGS. 2A-2B may be structured similarly to the embodiment shown in FIGS. 1A-1C.

As shown in FIG. 2A, in some arrangements, the receptacle outer wall extension 140c may have a cooling fluid inlet passage extending therethrough and enabling cooling fluid CF to be introduced into the receptacle cavity 144. In some particular arrangements, as seen in FIG. 2A, the cooling fluid inlet passage is in the form of a gap 141 formed in the outer wall extension 140c. In other particular arrangements, as seen in FIG. 3, the cooling fluid inlet passage is in the form of a through-hole 149 extending through the outer wall extension 140c. FIG. 3 shows a coolant feed pipe 151 injecting a coolant fluid (such as an oil) into the receptacle cavity 144 through the hole 149.

Referring to FIGS. 2A and 2B, in some arrangements, the inner wall extension 138c may extend along only a portion of the receptacle inner wall 138. This arrangement may be employed for a receptacle that is to be oriented as shown in FIG. 2A during operation of the motor, with both a central axis of the stator and the central axis X2 of the receptacle 130 extending generally horizontally. In this arrangement, the inner wall extension 138c may function as an impingement surface for guiding cooling fluid CF entering the cavity 144 through the cooling fluid inlet passage 141 formed in the outer wall extension 140c. The inner wall extension 138e may guide the cooling fluid CF therealong so that the cooling fluid CF proceeds along the cavity 144 as indicated by the arrows to cool wire end portions (not shown) extending between the stator body (not shown) and an encapsulation (not shown) affixed to the receptacle 130. In particular arrangement, the inner wall extension 138e may be structured to extend directly opposite the inlet passage 141 for an arc length of at least 180° along the base portion inner edge 134 (i.e., extending to at least 90° to either side from a centerline C1 of the inlet passage 141). This arrangement may direct cooling fluid CF entering the inlet passage 141 to flow along the inner wall extension 138e to either side of the inlet passage 141 and proceed along the cavity 144 to cool the wire ends residing in the cavity. Past the end edges 138a and 138b of the inner wall extension 138c, the cooling fluid CF may flow under gravity along the cavity 144 toward the drain passage 146 formed in the outer wall extension 140e. In particular arrangements, the inner wall 138 may be structured to extend directly opposite the inlet passage 141 for an arc length of at least 220° along the inner wall 138 to help ensure that cooling fluid CF remains in the cavity 144 passage as it proceeds toward drain passage 146.

As shown in FIG. 2A, in some arrangements, the inner wall extension 138e may have at least one cooling fluid drain passage extending therethrough. In some particular arrangements, the at least one cooling fluid drain passage is in the form of a gap structured as previously described and formed in the inner wall extension 138c. In other particular arrangements, the at least one cooling fluid drain passage is in the form of at least one through-hole 139 extending through the inner wall extension 138e. In some more particular arrangements, the at least one cooling fluid drain passage is in the form of a plurality of through-holes 139 extending through the inner wall extension 138c as shown in FIG. 2A. Drain passage(s) 139 may enable drainage of excess oil impinging on inner wall extension 138c.

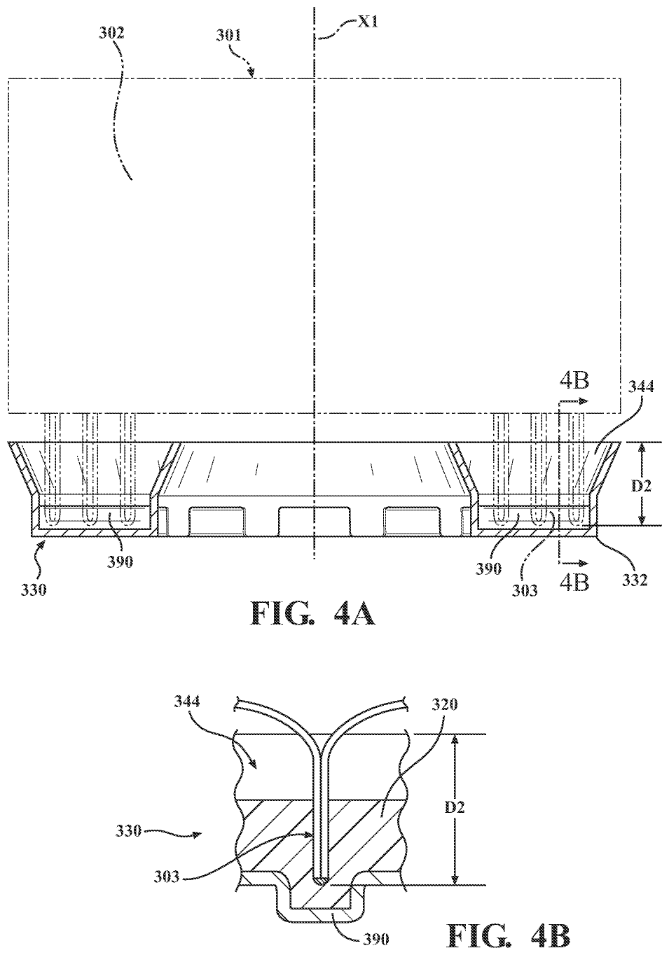

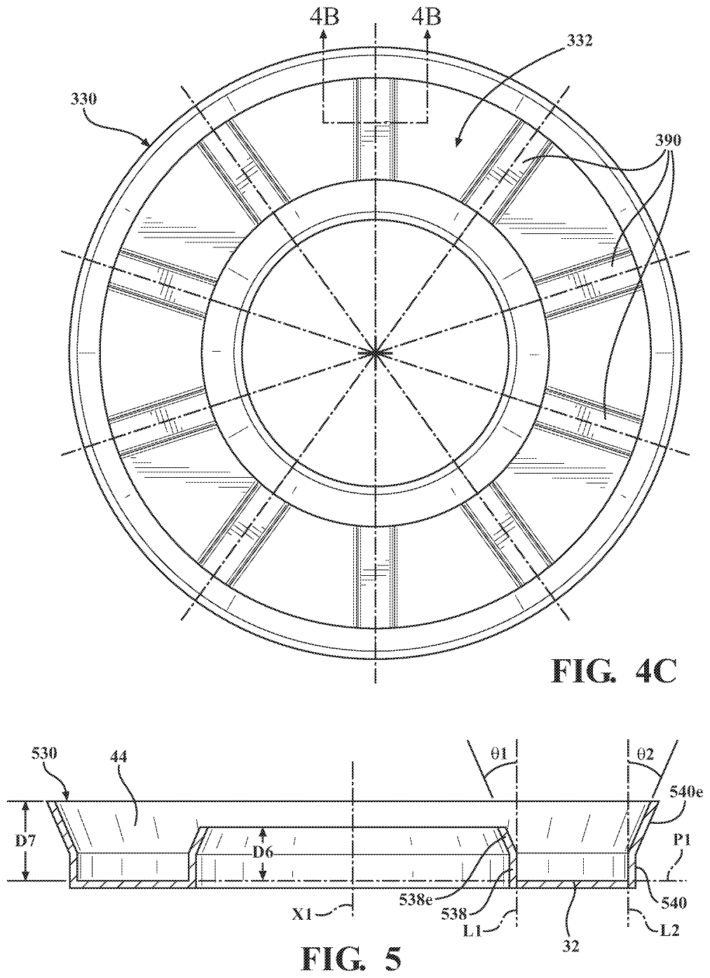

FIG. 4A is a schematic cross-sectional view of another stator 301 having wire ends 303 extending a second distance D2 into an encapsulation receptacle 330 from a stator body 302, where the second distance D2 is relatively greater than the first distance D1 shown in FIGS. 1E and 1F. FIGS. 4A-4C also show an embodiment 330 of the encapsulation receptacle incorporating a plurality of radially-extending grooves 390 structured to accommodate therein stator wire ends that extend relatively greater distances into the receptacle. FIG. 4B is a schematic cross-sectional view of a portion of the receptacle shown in FIG. 4A. FIG. 4C is a schematic plan view of the receptacle 330 shown in FIG. 4A.

Referring again to FIG. 1E, in some arrangements of the receptacle (e.g., receptacle 30), the base portion 32 defines a flat plane P1 forming a bottom of the cavity 44. For the encapsulation process, the wire ends are suspended above the bottom of the cavity. However, in some stator designs, due to factors such as the structures and arrangement of the stator wire ends, the method used to weld the wire ends together, and the distance at which the stator body must be suspended above the receptacle, the welded wire ends may extend deeper into the receptacle and farther from the stator body than in other designs. For example, referring to FIGS. 1E, 1F, and 4A-4B, wire ends 203 welded using a laser welding process may extend up to a first distance D1 from the stator body 202, while wire ends 303 (shown in FIGS. 4A and 4B) welded using a gas tungsten arc (or “TIG”) welding process may extend up to a second, relatively greater distance D2 from the stator body 302.

For wire ends that extend a relatively shorter distance D1 from the stator body 202 as seen in FIGS. 1E and 1F, a receptacle having a base portion defining a single flat bottom plane P1 as shown in 1E and IF may be sufficient. However, referring to FIGS. 4A-4C, to provide sufficient all-around encapsulation of welded wire ends 303 extending relatively farther into the receptacle cavity 344, some embodiments of the receptacle (such as receptacle 330 shown) may include a series of radially-extending grooves 390 formed in the base portion 332 and structured to receive the welded wire ends 303 (or portions of the welded wire ends) therein. The grooves 390 may be structured to accommodate an associated radially-aligned arrangement of welded wire ends 303 extending from the annular stator body 302. The grooves 390 may also aid in maintaining a relatively constant thickness of encapsulation material surrounding the wire ends 303 in cases where the wire ends project relatively farther into the receptacle cavity 344.

FIG. 5 is a schematic cross-sectional view similar to the view of FIG. 1C, showing another alternative embodiment 530 of the receptacle. In one or more arrangements, the receptacle embodiment 530 of FIG. 5 may be structured the same as the embodiment shown in FIGS. 1A-1C, except for the structures of the inner and outer wall extensions 538e and 540c. Referring to FIG. 5, in one or more arrangements, the inner wall extension 538e extends to a first perpendicular distance D6 from a plane P1 of the base portion 532, and the outer wall extension 540e extends to a second perpendicular distance D7 from the plane P1 of the base portion 532, with the second perpendicular distance D7 being greater than the first perpendicular distance D6. In this arrangement, the relatively lower inner wall extension 538e may enable cooling oil to be injected into the receptacle 530 along the inner wall extension 538c, while the relatively higher outer wall extension 540e may operate to deflect at least a portion of oil that might otherwise flow out of the receptacle 530 over a top of the outer wall extension 540c. This oil may be deflected back into the receptacle 530 for further circulation within the cavity 544 and cooling of the stator wires.

Embodiments of the encapsulation receptacle may be fabricated using any suitable method or methods (e.g., injection molding, casting, etc.) The encapsulation receptacle may be formed from any suitable material, such as iron, aluminum, or a polymer, for example. Polymer versions of the encapsulation receptacle may contain thermally conductive fillers such as iron, aluminum, graphite, graphene, ceramics, carbon, and/or metallic additives to enhance thermal conductivity and promote resistance to high temperatures.

The encapsulation receptacle embodiments described herein operate to contain and shape the encapsulation material during the encapsulation process. The receptacle also includes features that control the flow of liquid coolant material introduced into the receptacle cavity during operation of the motor, to help ensure a flow of coolant material to exposed portions of the stator wires and help prevent undesirable “hot spots” in the mass of stator wire ends.

As described herein, the cooling fluid CF may be formulated to cool portions of the stator wires residing in the receptacle cavity but not encapsulated in the encapsulation material. This provides a degree of cooling of the stator during operation of the motor. In one or more arrangements, suitable cooling fluids include various oils and specially-formulated liquid cooling media. The features of the receptacle embodiments described herein may be structured to facilitate flow of liquid coolant along and between the stator wire ends received in the cavity, to help cool the wires.

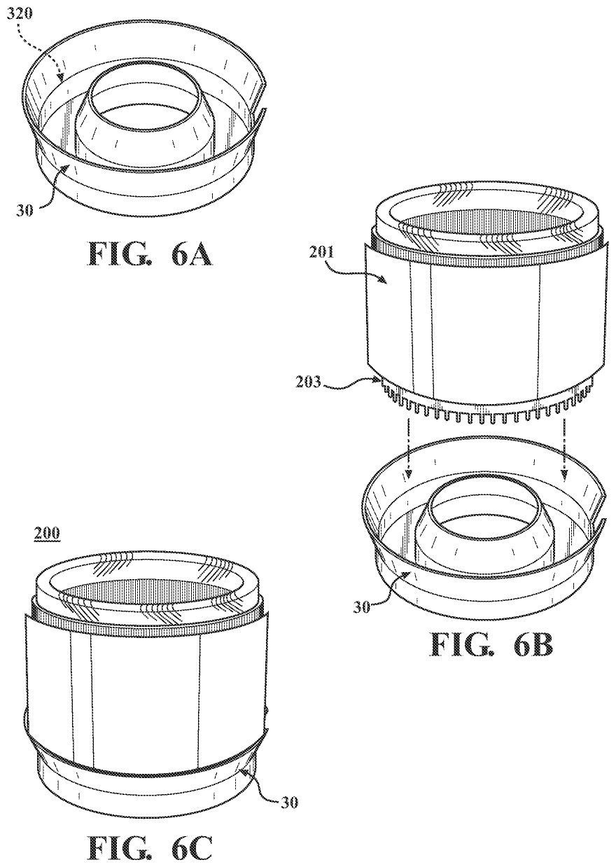

FIGS. 6A-6C are schematic views illustrating steps of an exemplary encapsulation method incorporating an embodiment of the encapsulation receptacle described herein. Referring to FIG. 6A, in a first step, an embodiment of the encapsulation receptacle (such as receptacle 30 previously described) may be positioned on a flat surface with the cavity 44 facing upwardly. Then, a quantity of a suitable encapsulation material 320 may be deposited into the cavity 44 until a desired level of encapsulation material 320 in the cavity 44 is reached. Next, in FIG. 6B the stator 201 may be positioned above the receptacle 30 and then lowered toward the receptacle to a position (shown in FIG. 6C) where the wire ends 203 are sufficiently immersed in the encapsulation material 320. The stator 201 may then be suspended in this position relative to the receptacle 30 while the encapsulation material 320 undergoes a hardening procedure (for example, an oven cure or a period of air drying). When the encapsulation material 320 hardens, the receptacle 30 has become affixed to the encapsulation material 320, thereby becoming part of the stator assembly.

Any of a variety of encapsulation materials may be used. Desirable properties of the encapsulation material may include good edge coverage (to help completely cover the sharp edges of exposed wire ends and welded portions of the wire ends), good thermal shock resistance (in a temperature range of at least −40° C. to 150° C. inclusive) to avoid cracking or other degradation of the material during temperature cycling of the wire ends, good thermal resistance up to temperatures of about 200° C., chemical compatibility with liquid coolant materials, and abrasion resistance to prevent wear of the material due to fine metal particles suspended in EV (electric vehicle) fluid and coolant material.

Depending on the cure chemistry of the encapsulation material, the entire stator assembly may be placed in an oven for curing, or the magnetic coils of the stator may be heated by application of an electric current to cure the encapsulation material. Alternatively, the encapsulation material may be curable at room temperature. The encapsulation material may also contain thermally conductive but electrically insulating additives to facilitate heat transfer away from the encapsulated portions of the wires.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5C, but the embodiments are not limited to the illustrated structure or application.

While recited characteristics and conditions of the invention have been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An encapsulation receptacle for a motor stator assembly, the receptacle comprising:
an annular base portion having a central axis;
an inner wall extending from the base portion;
an outer wall extending from the base portion opposite the inner wall, the base portion, the inner wall, and the outer wall combining to define a cavity structured to hold a quantity of encapsulation material inserted therein;
an inner wall extension extending from the inner wall in a direction toward the central axis;
an outer wall extension extending from the outer wall in a direction away from the central axis; and
at least one drain passage extending through at least one of the outer wall extension and the inner wall extension and structured to enable drainage of a cooling fluid from the cavity.

2. The receptacle of claim 1, wherein the inner wall extends perpendicularly from an inner edge of the base portion.

3. The receptacle of claim 1, wherein the outer wall extends perpendicularly from an outer edge of the base portion.

4. The receptacle of claim 1, wherein the at least one drain passage comprises at least one through-hole extending through the outer wall extension.

5. The receptacle of claim 4, wherein the at least one drain passage comprises a plurality of through-holes extending through the outer wall extension.

6. The receptacle of claim 1, wherein the at least one drain passage comprises at least one gap formed in the outer wall extension.

7. The receptacle of claim 1, wherein the outer wall extension has a coolant inlet passage extending therethrough.

8. The receptacle of claim 7, wherein the coolant inlet passage comprises a gap formed in the outer wall extension.

9. The receptacle of claim 7, wherein the coolant inlet passage comprises a through-hole extending through the outer wall extension.

10. The receptacle of claim 1, wherein the inner wall extension has at least one drain passage extending therethrough.

11. The receptacle of claim 10, wherein the at least one drain passage comprises a gap formed in the inner wall extension.

12. The receptacle of claim 10, wherein the at least one drain passage comprises at least one through-hole extending through the inner wall extension.

13. The receptacle of claim 12, wherein the at least one drain passage comprises a plurality of through-holes extending through the inner wall extension.

14. The receptacle of claim 1, wherein the base portion includes a plurality of radially-extending grooves formed therein.

15. The receptacle of claim 1 wherein the inner wall extension is structured to extend for an arc length of at least 180° along an edge of the inner wall.

16. The receptacle of claim 1, wherein the inner wall extension extends from the inner wall so as to form an angle in a range of 0°-30° inclusive with respect to a line extending parallel to the central axis and intersecting an inner edge of the base portion.

17. The receptacle of claim 1, wherein the outer wall extension extends from the outer wall so as to form an angle in a range of 0°-30° inclusive with respect to a line extending parallel to the central axis and intersecting an outer edge of the base portion.

18. The receptacle of claim 1, wherein the inner wall extension extends to a first perpendicular distance from a plane of the base portion, and the outer wall extension may also extend to the first perpendicular distance from the plane of the base portion.

19. The receptacle of claim 1, wherein the inner wall extension extends to a first perpendicular distance from a plane of the base portion, wherein the outer wall extension extends to a second perpendicular distance from the plane of the base portion, and wherein the second perpendicular distance is greater than the first perpendicular distance.

20. A motor stator assembly comprising:
a motor stator;
an encapsulation receptacle in accordance with claim 1; and
an encapsulation positioned in the receptacle and structured to insulate and immobilize wire ends of the stator with respect to each other.
